(19) United States
(12) Patent Application Publication
(10) Pub. No.: US 2009/0006368 A1
(43) Pub. Date: Jan. 1, 2009

(54) Automatic Video Recommendation

(75) Inventors: Tao Mei, Beijing (CN); Xian-Sheng Hua, Beijing (CN); Bo Yang, Harbin (CN); Linjun Yang, Beijing (CN); Shipeng Li, Redmond, WA (US)

Correspondence Address: LEE & HAYES PLLC, 601 W Riverside Avenue, Suite 1400, SPOKANE, WA, 99201, US

(73) Assignee: MICROSOFT CORPORATION, Redmond, WA (US)

(21) Appl. No.: 11/771,219

(22) Filed: Jun. 29, 2007

(51) Int. Cl. G06F 17/30; G06F 3/00

(52) U.S. Cl. 707/5; 715/719; 707/E17.017

(57) ABSTRACT

Automatic video recommendation is described. The recommendation does not require an existing user profile. The source videos are directly compared to a user selected video to determine relevance, which is then used as a basis for video recommendation. The comparison is performed with respect to a weighted feature set including at least one content-based feature, such as a visual feature, an aural feature and a content-derived textural feature. Multimodal implementation including multimodal features (e.g., visual, aural and textural) extracted from the videos is used for more reliable relevance ranking. One embodiment uses an indirect textural feature generated by automatic text categorization based on a set of predefined category hierarchy. Another embodiment uses self-learning based on user click-through history to improve relevance ranking.

### BACKGROUND

Internet video is one of the fastest-growing sectors of online media today. Driven by the coming age of the Internet generation and the advent of near-ubiquitous broadband Internet access, online delivery of video content have surged to an unprecedented level in recent years. According to some reports, in the United States alone, more than 140 million people (69% among those who are surveyed) have watched video online, while 50 million doing so weekly. This trend has brought a variety of online video services, such as video search, video tagging and editing, video sharing, video advertising, and so on. As a result, today's online users face a daunting volume of video content from a variety of sources serving various purposes, ranging from commercial video service to user generated content, and from paid online movies to video sharing, blog content, IPTV and mobile TV. There is an increasing demand of an online video service to push the “interesting” or “relevant” content to the targeted people at every opportunity.

One way to effectively push interesting or relevant content to the targeted viewers is using automatic video recommendation systems. Video recommendation saves the users and/or the service providers from manually filtering out the unrelated content and finds the most interesting videos according to user preferences. While many existing video-oriented sites, such as YouTube, MySpace, Yahoo! Google Video and MSN Video, have already provided recommendation services, most of them recommend the relevant videos based on registered user profiles for the information related to user interest or intent. The recommendation is further based on surrounding text information (such as the title, tags, and comments) of the videos in most systems. A typical recommender system receives recommendations provided by users as inputs, and then aggregates and directs to appropriate recipients aiming at good matches between recommended items and users.

Research on traditional video recommendation started from 1990s. Many recommendation systems have been designed in diverse areas, such as movies, TVs, web pages, and so on. Most of these recommenders assumed that a sufficient collection of user profiles is available. In general, user profiles mainly come from two kinds of sources: direct profiles, such as a user selection of a list of predefined interests, and indirect profiles, such as user ratings of a number of items. In video recommendation systems that rely on user profiles, regardless of what kinds of items are recommended, the objective is to recommend the items that match the user profiles. In other words, the “relevance” in traditional recommendation systems is based on pre-manifested user interests on record.

However, in many real-life cases, a user visits a webpage anonymously and is less likely to login the system to provide his/her personal profile. Traditional recommendation approaches thus cannot be directly applied in this type of situations.

An alternative to video recommendation is to adopt the techniques used in video search service. However, there are some important differences between video search and video recommendation. First, they have different objectives. Search engines respond to a specific user query to match at a concept level what the user is searching for, while video recommendation system is to guess what might be most interesting to the user at the moment. Video search finds videos that mostly “match” specific queries or a query image, while video recommendation ranks the videos which may be most “relevant” or “interesting” to the user. Using video search, those videos don't directly “match” the user query will not be returned in a video search system even if they are relevant or interesting to the user. For example, suppose a user inputs a query of “orange” in a video search system, entries containing “apple” but not “orange” will not be included in the search result, even though such entries may be of interest to the user who is interested in “oranges”.

Second, video search and video recommendation also have different inputs. The input of video search comes from a set of keywords or images specifically entered by the user. Because such user inputs are usually simple and don't have specific ancillary properties such as title, tags, comments, video search tends to be single modal. In contrast, the input of video recommendation may be a system consideration without a specific input entered by the user and intended to be matched. For example, a user of a video recommendation system may not necessarily be searching anything in particular, or at least have not entered a specific search query for such. Yet it may still be the job of a video recommendation system to provide video recommendation to the user. Under such circumstances, the video recommendation system may need to formulate an input based on inferred using intent or interest.

For forgoing reasons, there is a need for a video recommendation system and method that suit for a broader range of online video users including, but not limited to, those who may not perform a specific search and may also not have an existing user profile.

### SUMMARY

Automatic video recommendation is described. They recommendation scheme does not require a user profile. The source videos are directly compared to a user selected video to determine relevance, which is then used as a basis for video recommendation. The comparison is performed with respect to a weighted feature set including at least one content-based feature, such as a visual feature, an aural feature and a content-derived textural feature. Content-based features may be extracted from the video objects. Additional features, such as user entered features, may also be included in the feature set. In some embodiments, multimodal implementation including multimodal features (e.g., visual, aural and textural) extracted from the videos is used for more reliable relevance ranking. The relevancies of multiple modalities are fused together to produce an integrated and balanced recommendation. A corresponding graphical user interface is also described.

One embodiment uses an indirect textural feature generated by automatic text categorization based on a set of predefined category hierarchy. Relevance based on the indirect text is computed using distance information measuring hierarchical separation from a common ancestor to the user selected video object and the source video object. Another embodiment uses self-learning based on user click-through history to improve relevance ranking. The user click-through history is used for adjusting relevance weight parameters within each modality, and also for adjusting relevance weight parameters among the plurality of modalities.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE FIGURES

The detailed description is described with reference to the accompanying figures. In the figures, the left-most digit(s) of a reference number identifies the figure in which the reference number fist appears. The use of the same reference numbers in different figures indicates similar or identical items.

FIG. 1 shows an exemplary video recommendation process.

FIG. 2 shows and exemplary multimodal video recommendation process.

FIG. 3 shows and exemplary environment for implementing the video recommendation system.

FIG. 4 shows and exemplary user interface for the video recommendation system.

FIG. 5 shows and exemplary hierarchical category tree used for computing category-related relevance.

### DETAILED DESCRIPTION

### Overview

Described below is a video recommendation system based on determining relevance of a video object measure against a user selected video object with respect to the feature set and weight parameters. User history, without requiring an existing user profile, is used to refine weight parameters for dynamic recommendation. The feature set includes at least one content-based feature.

In this description, the concept of “content-based” is broadened from the conventional usage of the term. “Content-based” features include not only multimodal (textural, visual, and aural, etc.) features that are directly extracted from the digital content of a digital object such as a video, but also ancillary features obtained from information that has been previously added or attached to the video object and has become a part of the video object subsequently presented to the current user. Examples of such ancillary features include tags, subject lines, titles, ratings, classifications, and comments. In addition, “content-based” features also include features indirectly derived from the content-related nature or characteristics of a digital object. One example for indirect content-based feature is hierarchical category information of a video object as described herein.

Some embodiments of the video recommendation system take advantage of multimodal fusion and relevance feedback. Given an online video document, which usually consists of video content and related information (such as query, title, tags, and surroundings), video recommendation is formulated as finding a list of the most relevant videos in terms of multimodal relevance. The multimodal embodiment of the present video recommendation system expresses the multimodal relevance between two video documents as the combination of textual, visual, and aural relevance. Furthermore, since different video documents have different weights of the relevance for three modalities, the system adopts relevance feedback to automatically adjust intra-weights within each modality and inter-weights among different modalities by user click-though data, as well as attention fusion function to fuse multimodal relevance together. Unlike traditional recommenders in which a sufficient collection of user profiles is assumed available, the present system is able to recommend videos without user profiles, although the existence of such user profiles may further help the video recommendation. The system has been tested using videos searched by top representative queries from more than 13,000 online videos, showing effectiveness of the video recommendation scheme described herein.

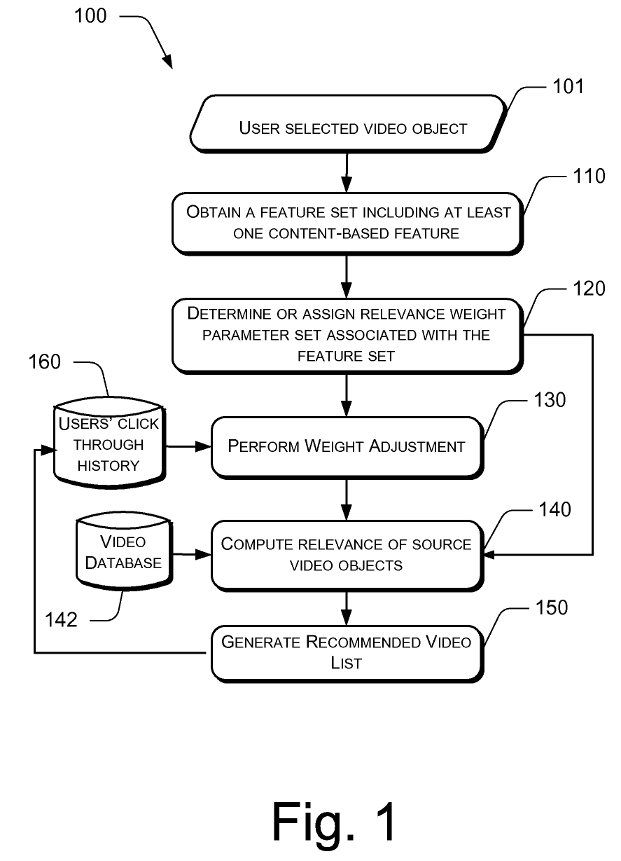

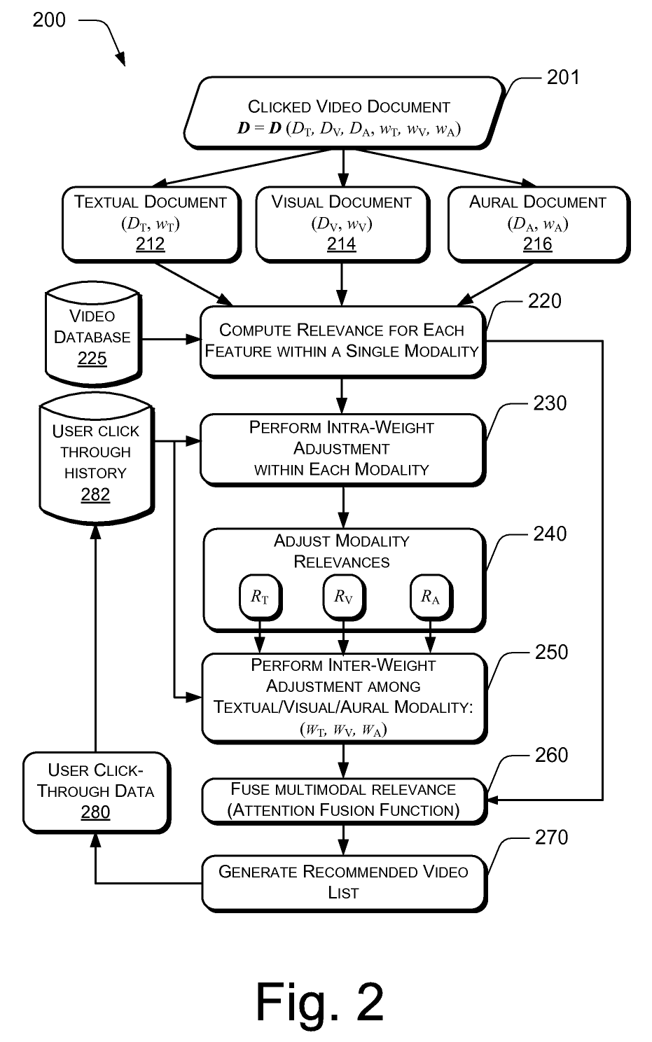

Exemplary processes for recommending videos are illustrated with reference to FIGS. 1-2. The order in which the processes described is not intended to be construed as a limitation, and any number of the described method blocks may be combined in any order to implement the method, or an alternate method.

FIG. 1 shows an exemplary video recommendation process. The process 100 starts with input information at block 101 which includes a user selected video object (such as a movie or video recording). In one embodiment, the user selected video object is a video object that has been recently clicked by the user. However, the user selected video object may be selected in any other manner, or even at any time and place, as well as the selected video object provides a relevant basis for evaluating the user intent or interest.

At block 110, the process 100 obtains a feature set of the user selected video object. The feature set includes at least one content-based feature, such as a textural feature, visual feature, or borrow feature. As will be illustrated further below, the feature set may also be multimodal including multiple features from different modalities. In addition to the content-based feature(s), the feature set may also include additional features such as features added by the present user. Such additional features may or may not become part of the video object to be presented to subsequent users.

At block 120, the process determines or assigns a relevance weight parameter set associated with the feature set. The relevance weight parameters, or shortly weights, indicate the weight the associated feature set has on the relevance computation. Generally, one relevance weight parameter is associated with a feature of the feature set. If the feature set has multiple features, the corresponding relevance weight parameter set may include multiple weights. The weights may be determined (or adjusted) as described herein. In some circumstances, especially for initiation, the weights may be assigned to have appropriate initial values. After determining or assigning the weights, the process may proceed to block 140 to compute relevance of source video objects, but may also optionally go to block 130 to perform weight adjustment based on feedback information of user click-through history.

At block 130, the process performs weight adjustment based on feedback information such as user click-through history. As will be illustrated further below, weight adjustment may include intra-weight adjustment within a single modality and inter-weight adjustment amount multiple modalities.

At block 140, the process computes relevance of source video objects, which are available from video database 142, which can be either a single integrated database or a collection of databases from different locations hosted by multiple servers over a network. The relevance of each source video object is computed relative to the user selected video object with respect to the feature set and the relevance weight parameter set. In one embodiment, a separate relevance is computed with respect to each feature of the feature set. As will be illustrated further below, when multiple modalities are involved, separate relevance data are eventually fused to create a general or average relevance.

At block 150, the process generates a recommended video list of the source video objects according to the ranking of the relevance determined for each source video object. The recommended video list may be displayed at a display space viewable by the user. For the display purpose, the recommended video list may include indicia each corresponding to one of the plurality of source video objects included in the recommended video list. Each indicium may include an image representative of the video object and may further include a surrounding text such as a title or brief introduction of the video object. To facilitate interactive operation by the user, each indicium may have an active link (such as a clickable link) to the corresponding source video object. The user may view the source video object by previewing, streaming or downloading.

As will be further illustrated below, in one embodiment, once the user selects (e.g., by clicking the link) a source video object, the selected source video object becomes the new user selected video object in block 101, and the process 100 enters into a new iteration and dynamically updates the recommended video list.

In general, due to the limitation of the display area, only a portion of the recommended video list generated may be displayed to be viewed by the user. Preferably, source video objects that have the highest relevance ranking are displayed first.

As the user clicks through the displayed recommended video list, the user may manifest a different level of interest to the selected video object. For example, if the user spends a relatively longer time viewing a selected video object, it may indicate a higher interest and hence higher relevance of the selected video object. The user may also be invited to explicitly rate the relevance, but it may be more preferred that such knowledge be collected without interrupting the natural flow of acts of the user browsing and watching videos of his or her interest.

The data of user click-through history 160 may be collected and used as a feedback to help the process to further adjust weight parameters (block 130) to refine the relevance computation. The user click-through history 160 may contain the click-through history of the present user, but may also contain accumulated click-through histories of other users (including the click-through history of the same user from previous sessions).

The feedback of click-through history 160 may be used to accomplish dynamic recommendation. In one embodiment, the recommended video list is generated dynamically whenever a change has been detected with respect to the user selected video object 101. The change with respect to the user selected video object may be that the user has just selected a video object different from the current user selected video object 101. Additionally or alternatively, the change with respect to the user selected video object may be that a new content of the same user selected video object 101 is now playing. For example, the video object 101 may have a series of content shots (frames). When the new now-playing content shots (frames) are substantially different from the previously played content shots of the user selected video object, a meaningfully different recommended video list may be generated based on the new content shots which now serve as the new user selected video object 101 as a basis of relevance determination.

FIG. 2 shows an exemplary multimodal video recommendation process. The process 200 is similar to the process 100 but contains further detail regarding the multimodal process.

The process 200 starts at block 201 with a click video document D, which is represented by D=D (D_{T}, D_{V}, D_{A}, w_{T}, w_{V}, w_{A}), where D_{T}, D_{V}, and D_{A} represents textual, visual and aural documents, and w_{T}, w_{V}, w_{A} denote the weight parameters (weights) of textual, visual and aural document, respectively.

Blocks 212, 214 and 216 indicate the documents of single modal Dᵢ (i={T, V, A}) which can be represented by a set of features and the corresponding weights Di=Dᵢ (fᵢ, wᵢ). In the present description, the term “document” is used broadly to indicate an information entity and does not necessarily correspond to a separate “file” in the ordinary sense.

At block 220, the process computes relevance of source video objects for each feature within a single modality. The source video objects are supplied by video database 225. A process similar to process 100 of FIG. 1 may be used for the computation of block 220 for each modality. Upon finishing computing the relevance of each modality, the process may either proceed to block 260 to perform fusion of multimodal relevance, or alternatively proceed to block 230 for further refinement of the relevance computation.

At block 230, the process performs intra-weight adjustment within each modality to adjust weight parameters w_{T}, wᵥ, w_{A}. The intra-weight adjustment may be assisted by feedback data such as the user click-through history 282. Detail of such intra-weight adjustment is described further in a later section of this description.

At block 240, the process adjusts relevance of each modality based on the adjusted weight parameters and outputs intra-adjusted relevance R_{T}, R_{V} and R_{A} for textual modality, visual modality and aural modality, respectively.

At block 250, the process performs inter-weight adjustment amount multiple modalities to further adjust weight parameters w_{T}, w_{V}, w_{A}. The intra-weight adjustment may be assisted by feedback data such as the user click-through history 282. Detail of such intra-weight adjustment is described further in a later section of this description.

At block 260, the process fuses multimodal relevance using a suitable fusion technique (such as Attention Fusion Function) to produce a final relevance for each source video object that is being evaluated for recommendation.

At block 270, the process generates a recommended video list of the source video objects according to the ranking of the relevance determined for each source video object. The recommended video list may be displayed at a display space viewable by the user.

As the user clicks through the displayed recommended video list, the user may manifest a different level of interest to the recommended items. The user click-through data 280 may be collected and added to user click-through history 282 to be used as a feedback to help the process to further adjust weight parameters (blocks 230 and 250) to refine the relevance computation. The user click-through history 282 may contain the click-through history of the present user, but may also contain accumulated click-through histories of other users (including the click-through history of the same user from previous sessions), especially users with common interests. User interests may be manifested by user profiles.

The above-described video recommendation system may be implemented with the help of computing devices, such as personal computers (PC) and servers.

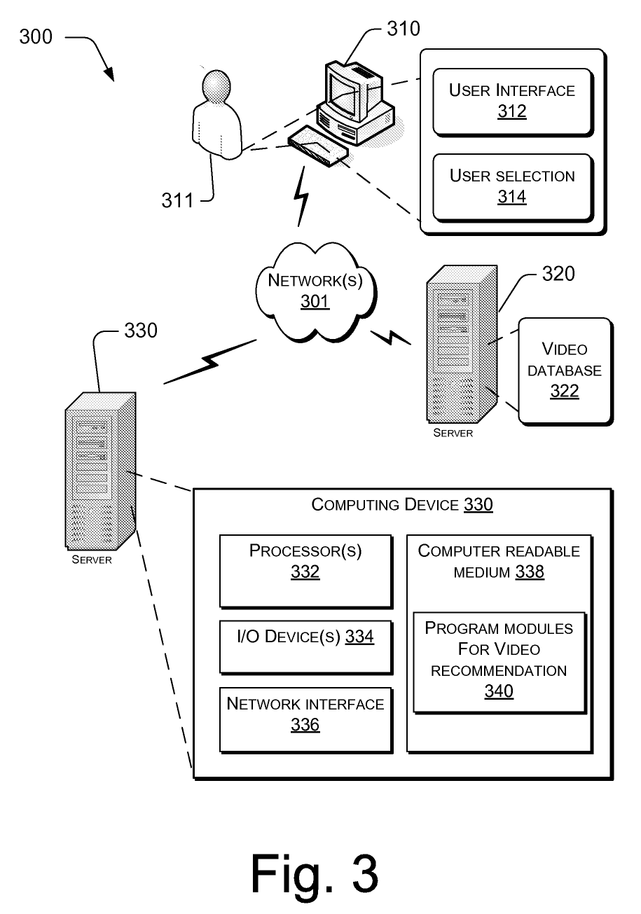

FIG. 3 shows an exemplary environment for implementing the video recommendation system. The system 300 is network-based online video recommendation system. Interconnected over network(s) 301 are end user computer 310 operated by user 311, server(s) 320 storing video database 322 and computing device 330 installed with program modules 340 for video recommendation. User interface 312, which will be described in further detail below, is rendered through end user computer 310 interacting with the user 311. User input and/or user selection 314 are entered through end user computer 310 by the user 311.

The program modules 340 for video recommendation are stored on computer readable medium 338 of computing device 330, which in the exemplary embodiment is a server having processor(s) 332, I/O devices 334 and network interface 336. Program modules 340 contain instructions which, when executed by processor(s) 332, cause the processor(s) 332 to perform actions of a process described herein (e.g., the processes of FIGS. 1-2) for video recommendation. For example, problem modules 340 may contain instructions which, when executed the processor(s) 332, cause the processor(s) 332 to do the following:

extract from a user selected video object a feature set including at least one content-based feature;

determine or assign a relevance weight parameter set including a relevance weight parameter associated with the content-based feature;

determine a relevance of each of multiple source video objects to the user selected video object with respect to the feature set and the relevance weight parameter set; and

generate a recommended video list of at least some of the multiple source video objects according to a ranking of the relevance determined for each source video object.

The recommended video list is displayed, at least partially, on a display of the end user computer 310 and interactively viewed by the user 311.

It is appreciated that the computer readable media may be any of the suitable memory devices for storing computer data. Such memory devices include, but not limited to, hard disks, flash memory devices, optical data storages, and floppy disks. Furthermore, the computer readable media containing the computer-executable instructions may consist of component(s) in a local system or components distributed over a network of multiple remote systems. The data of the computer-executable instructions may either be delivered in a tangible physical memory device or transmitted electronically.

It is also appreciated that a computing device may be any device that has a processor, an I/O device and a memory (either an internal memory or an external memory), and is not limited to a personal computer or a server.

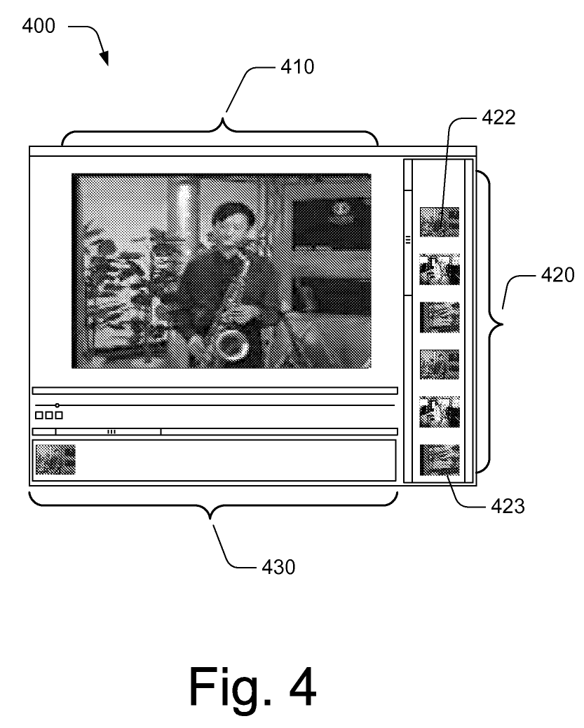

FIG. 4 shows an exemplary user interface for the video recommendation system. The user interface 400 has a now-playing area 410 for displaying a user selected video object and a video content recommendation area 420 for displaying a video recommendation list comprising multiple indicia (e.g., 422 and 423) each corresponding to a recommended source video object. The video recommendation list is displayed according to a ranking of relevance determined for each recommended source video object relative to the current user selected video object (displayed in the now-playing area 410). The relevance is measured what respect to a feature set and the relevance weight parameter set. As described herein, the feature set may include at least one content-based feature obtained or extracted from the video objects.

The user interface 400 further includes means for making a user selection of a recommended source video object among the displayed video recommendation list. In the example shown in FIG. 4, such means is provided by active (e.g., clickable) links associated with indicia (e.g., 422 and 423) each corresponding to a recommended source video object. Upon selecting (e.g., clicking) the recommended source video object through its associated indicium (e.g., 422 or 423), the user interface 400 dynamically updates the now-playing area 410. In one embodiment, the user interface 400 may also dynamically update the video content recommendation area 420 according to the new video object selected by the user and displayed in the now-playing area 410. In another embodiment, the user interface 400 may dynamically update the video content recommendation area 420 upon detection of a new now-playing content of the user selected video object. For example, when the new now-playing content is substantially different from a previously played content of the user selected video object, a different recommended video list would be generated based on the new now-playing content.

### Algorithms

Further detail of the algorithms and techniques for video recommendation is described with exemplary embodiments below. The techniques described herein are particularly suitable for automatic multimodal online video recommendation, as illustrated below.

System Framework:

The input to the present video recommendation system is a video document D, which is represented by textual, visual and aural documents as D=(D_{T}, D_{V}, D_{A}). In one exemplary embodiment, the video document D is a user selected video object. Given a video document D, the task of video recommendation is expressed as finding a list of videos with the best relevance to D. Since different modalities have different contributions to the relevance, this description uses (w_{T}, w_{V}, w_{A}) to denote the weight parameters (or weights) of textual, visual and aural document, respectively. The weight parameters (w_{T}, w_{V}, w_{A}) represent the weight given to each modality in relevance computation. A video document can thus be further represented by

D=D(D_{T},D_{V},D_{A},w_{T},w_{V},w_{A}) (1)

Similarly, the document of a single modal Dᵢ (i={T, V, A}) can be represented by a set of features and the corresponding weights:

Dᵢ=Dᵢ(fᵢ,wᵢ) (2)

where fᵢ=(fᵢ₁, fᵢ₂, . . . , fᵢₙ) is a set of features from modality i, and wᵢ=(wᵢ₁, wᵢ₂, . . . , wᵢₙ) is a set of corresponding weights. Let R(Dₓ, D_{y}) denote the relevance of two video documents Dₓ and D_{y}. The relevance between video document Dₓ and D_{y} in terms of modality i is denoted by Rᵢ(Dₓ, D_{y}), while the relevance in terms of feature fᵢⱼ is denoted by Rᵢⱼ(Dₓ, D_{y}).

Exemplary processes based on the system framework for online video recommendation have been illustrated in FIGS. 1-2. In the multimodal recommendation system shown in FIG. 2, for example, the process first computes the relevance in terms of a single modality by the weighted linear combinations of relevance between features (block 220) to obtain the multimodal relevance between the clicked video document and a source video document which is a candidate for recommendation. The process then fuses the relevance of single modality using attention fusion function (AFF) with proper weights (block 260). Exemplary weights suitable for this purpose are proposed in Hua et al., “An Attention-Based Decision Fusion Scheme for Multimedia Information Retrieval”, Pacific-Rim Conference on Multimedia, Tokyo, Japan, 2004.

The intra-weights within each modality and inter-weights among different modalities are adjusted dynamically using relevance feedback (blocks 230 and 250). An exemplary user interface is shown in FIG. 4.

Using textual features to compute the relevance of video documents is the most common method and can work well in most cases. However, not all concepts can be well described by text only. For instance, for a video about “beach”, the keywords related to “beach” may be “sky”, “sand”, “people”, and so on. But these words are probably also related to many other videos, such as “desert” and “weather”, which may be irrelevant to a “beach” video or uninteresting to a user who is currently interested in a beach video. In this case, it may be better to use visual features to describe “beach” rather than textual features. Furthermore, aural features are quite important for relevance in some music videos.

Given these considerations, one preferred embodiment of the present video recommendation system use visual and aural features in addition to textual features to augment the description of all types of online videos. The relevance from textual, visual and aural documents, as well as fusion strategy by AFF and relevance feedback are described further below.

Multimodal Relevance:

Video is a compound of image sequence, audio track, and textual information, each of which delivers information with its own primary elements. Accordingly, the multimodal relevance is represented by a combination of relevance from these three modalities. The textual, visual and aural relevance are described in further detail below.

Textual Relevance:

The present video recommendation system classifies textual information related to a video document into two kinds: direct text and indirect text. Direct text includes surrounding text explicitly accompanying the videos, and also includes text recognized by Automated Speech Recognition (ASR) and Optical Character Recognition (OCR) embedded in video stream. Indirect text includes text that is derived from content-related characteristics of the video. One example of the indirect text is titles or descriptions of video categories and category-related probabilities obtained by automatic text categorization based on a set of predefined category hierarchy. Indirect text may not explicitly appear with the video itself. For example, the word “vacation” may not be a keyword directly associated with a beach video but nevertheless interesting to a user who has shown interest in a beach video. Through proper categorization, the word “vacation” may be included into the indirect text to affect the relevance computation.

Thus a textual document D_{T} is represented using two kinds of features (f_{T1}, f_{T2}) as

D_{T}=D_{T}(f_{T1},f_{T2},w_{T1},w_{T2}) (3)

where w_{T1} and w_{T2} indicate the weights of f_{T1} and f_{T2}, respectively.

Direct text and indirect text may be processed using different models for relevance computation. For example, one embodiment uses a vector model to describe direct text but uses a probabilistic model to describe indirect text, as discussed further below.

Vector Model—In vector model, the textual feature of a document is usually defined as

f_{T1}=f_{T1}(k,w) (4)

where k=(k₁, k₂, . . . , kₙ) is a dictionary of all keywords appearing in the whole document pool, w=(w₁, w₂, . . . , wₙ) is a set of corresponding weights, n is the number of unique keywords in all documents.

A classic algorithm to calculate the importance of a keyword is to use the product of its term frequency (TF) and inverted document frequency (IDF), based on the assumption that the more frequently a word appears in a document and the rarer the word appears in all documents, the more informative it is. However, such approach may not be suitable in certain video recommendation scenarios. First, the number of keywords from online videos may be smaller than that from a regular text document, sometimes leading to a very small document frequency (DF). Under such circumstances, IDF, which may be defined as log(1/DF), is quite unstable. Second, most online content providers tend to use general keywords to describe their videos, such as using “car” to describe a video instead of using “Benz” to specify the brand of the car which may be a subject of the video. Using IDF in such cases may result in some non-informative keywords that overwhelm the informative keywords. For these reasons, one preferred embodiment uses term frequency (TF) to describe the importance of a keyword.

According to vector model, cosine distance is adopted as the measurement of textual relevance between document Dₓ and D_{y}

$${R}_{T 1} ( {D}_{x} , {D}_{y} ) = \frac{w ( {D}_{x} ) \cdot w ( {D}_{y} )}{\vert w ( {D}_{x} ) \vert \cdot \vert w ( {D}_{y} ) \vert} \qquad ( 5 )$$

where w(Dx) denotes the weights of Dx in vector model. Different kinds of text may have different weights. The more a text kind is related with the video document, the more important the text kind is regarded. For example, since the title and tags provided by content providers are usually more relevant to the uploaded videos, their corresponding weights may be set higher (e.g., 1.0). In comparison, the weights of comments, descriptions, ASR, and OCR may be lower (e.g., 0.1).

Probabilistic Model—Although vector model is able to present the keywords of a textual document, it may not be adequate to describe the latent semantics in the videos. For example, for an introduction to a music video named “flower”, “flower” is an important keyword and has a high weight in vector model. Consequently, many videos related to real flowers may be recommended by vector model. However, in reality the videos related to music may be more relevant to the music video named “flower”. To address this problem, one embodiment of the present video recommendation system leverages the categories and their corresponding probabilities obtained by probabilistic model. The embodiment uses text categorization based on Support Vector Machine (SVM) to automatically classify a textual document into a set of predefined category hierarchy. The category hierarchy may be designed according to the video database. One exemplary category hierarchy consists of more than 1k categories.

In the probability model, the second textual feature of D_{T} is represented as

f_{T2}=f_{T2}(C,P) (6)

where C=(C₁, C₂, . . . Cₘ) is a set of categories to which the textual document D_{T} is belonging with a set of probabilities P=(P₁, P₂, . . . , Pₘ).

The predefined categories make up a hierarchical category tree. Let d(Cᵢ) denote the depth of category Cᵢ in the category tree, measuring the distance from category Cᵢ to the root category. The depth of root is zero according to this notation. For two categories Cᵢ and Cⱼ, one may define l(Cᵢ, Cⱼ) as the depth of their first common ancestor in the hierarchical category tree. Then for two textual documents Dₓ, with a set of categories Cₓ=(C₁, C₂, . . . , Cₘ₁) and probabilities Pₓ=(P₁, P₂, . . . , Pₘ₁), and D_{y} with C_{y}=(C₁, C₂, Cₘ₂) and P_{y}=(P₁, P₂, . . . , Pₘ₂), the relevance in probabilistic model is defined as

$${R}_{T 2} ( {D}_{x} , {D}_{y} ) = {\sum }_{i = 1}^{m 1} {\sum }_{j = 1}^{m 2} R ( {C}_{i} , {C}_{j} ) \\ \{ \begin{matrix}{α}^{( d ( {C}_{i} ) - 𝓁 ( {C}_{i} , {C}_{j} ) )} {P}_{i} \cdot {α}^{( d ( {C}_{j} ) - 𝓁 ( {C}_{i} , {C}_{j} ) )} {P}_{j} & if 𝓁 ( {C}_{i} , {C}_{j} ) ) > 0 \\ 0 & otherwise\end{matrix} \qquad ( 7 )$$

where α is a predefined parameter to control the probabilities of upper-level categories. Intuitively, the deeper level two documents are similar at, the more related they are.

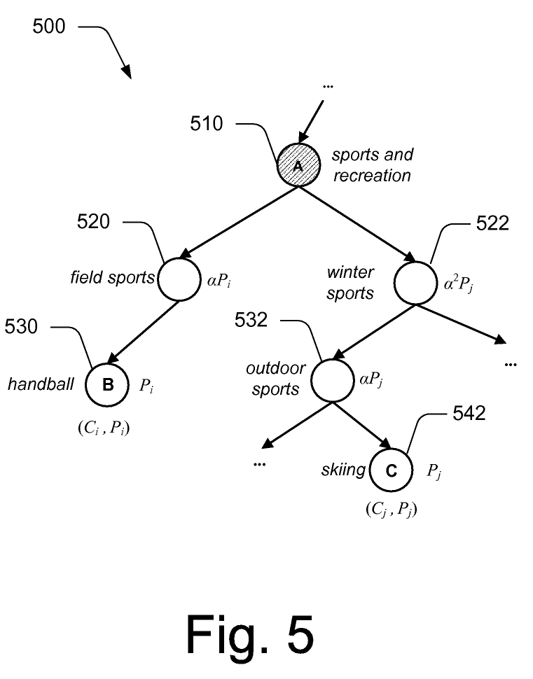

FIG. 5 shows an exemplary hierarchical category tree. The hierarchy category tree 500 has multiple categories (nodes) related to each other in a tree like hierarchical structure. The node 510 has lower nodes 520 and 522. The node 520 has lower node 530, and the node 522 has lower node 532 which has further lower node 542, and so on. To compute the relevance between two nodes 530 (Cᵢ, Pᵢ) and 542 (Cⱼ, Pⱼ), for example, a common parent node 510 is identified, and a relative depth from each of the two nodes 530 (Cᵢ, Pᵢ) and 542 (Cⱼ, Pⱼ) to the common category 510 may be used for relevance computation. The relative depth may be simply given by the number of steps going from each node (530 or 542) to the common parent node 510. In this case, the relative depth of node 530 (Cᵢ, Pᵢ) is 2, while the relative depth of node 542 (Cⱼ, Pⱼ) is 3.

According to equation (7), for the two nodes 530 and 542 represented by (Cᵢ, Pᵢ) and (Cⱼ, Pⱼ), the relevance according to probability model is given by

R(Cᵢ,Cⱼ)=α²Pᵢα³Pⱼ=α⁵PᵢPⱼ.

In one exemplary embodiment, α is fixed to 0.5.

Visual Relevance:

The visual relevance is measured by color histogram, motion intensity and shot frequency (average shot number per second), which have proved to be effective to describe visual content in many existing video retrieval systems. A visual document D_{V} is represented as

D_{V}=D_{V}(f_{V1},f_{V2},f_{V3},w_{V1},w_{V2},w_{V3}) (10)

where f_{V1}, f_{V2}, and f_{V3} represent color histogram, motion intensity, and shot frequency, respectively. For two visual documents Dₓ and D_{y}, the visual relevance of feature j (j=1, 2, 3) is defined as

R_{Vj}(Dₓ,D_{y})=1.0−|f_{Vj}(Dₓ)−f_{Vj}(D_{y})| (11)

Aural Relevance:

An aural document may be described using the average and standard deviation of aural tempos among all the shots. Average aural tempo represents the speed of music or audio, while standard deviation indicates the change frequency of music style. These features have proved to be effective to describe aural content.

As a result, an aural document D_{A} is represented as

D_{A}=D_{A}(f_{A1},f_{A2},w_{A1},w_{A2}) (14)

where f_{A1} and f_{A2} represent the average and standard deviation of aural tempo, respectively. For two aural documents Dₓ and D_{y}, the aural relevance of these features is defined as

R_{A1}(Dₓ,D_{y})=1.0−|f_{A1}=(Dₓ)−f_{A1}(D_{Y}) (15)

R_{A2}(Dₓ,D_{y})=1.0−|f_{A2}(Dₓ)−f_{A2}(D_{y})| (16)

Fusion of Multiple Modalities:

The modeling of relevance from individual channels has been described above. However, proper techniques may be needed for fusing these individual mortality relevancies to a final measurement for recommendation. An example of multimodal fusion method is described below. The method combines the relevancies from individual modality by attention fusion function and relevance feedback.

Fusion with Attention Fusion Function—In a preferred embodiment, a special fusion technique called Fusion with Attention Fusion Function rather than a simple linear combination method is used. Linear combination of the relevance of individual modality is a simple and often effective method for fusion. However, this approach may not be consistent with human's attention response. To overcome this problem, Attention Fusion Function (AFF) which simulates the human' attention characteristics as proposed in Hua et al., “An Attention-Based Decision Fusion Scheme for Multimedia Information Retrieval”, Pacific-Rim Conference on Multimedia, Tokyo, Japan, 2004, may be used.

The AFF based fusion is applicable when two properties called monotonicity and heterogeneity are satisfied. Specifically, the first property monotonicity indicates that the final relevance increases whenever any individual relevance increases; while the second property heterogeneity indicates that if two video documents present high relevance in one individual modality but low relevance in the other, they still have a high final relevance.

Monotonicity is easy to be satisfied in a typical video recommendation scenario. For heterogeneity, since two documents are not necessarily relevant even they are very similar in one feature, some care may need to be taken to ensure the satisfaction of condition. One embodiment first fuses the above relevancies into three channels: textual, visual, and aural relevance. If two documents have high textual relevance, they are considered probably relevant. But if two documents are only similar in visual or aural features, they may be considered not very relevant. Thus, this embodiment first filters out most documents in terms of textual relevance to ensure all documents are more or less relevant with the input document (e.g., a clicked video), and then calculates the visual and aural relevance within these documents only. Thus, according to the attention model, if under such conditions a document has high visual or aural relevance with the clicked video, the user is likely to pay more attention to this document than to others with lower (e.g., moderate) relevance scores.

Under the above conditions, monotonicity and heterogeneity are both satisfied, and AFF may be used to get better fusion results. Since different features are preferred to have different weights, a 3-dimensional AFF with weights described in Hua et al. is used to get a final relevance. For two documents Dₓ and D_{y}, the final relevance is computed as

$$R ( {D}_{x} , {D}_{y} ) = \frac{{R}_{avg} + \frac{1}{2 ( n - 1 ) + n γ} {\sum }_{i = T , V , A} \vert {nw}_{i} {R}_{i} ( {D}_{x} , {D}_{y} ) - {R}_{avg} \vert}{W} \\ {R}_{avg} = {\sum }_{i = T , V , A} {w}_{i} {R}_{i} ( {D}_{x} , {D}_{y} ) , and \\ W = 1 + \frac{1}{2 ( n - 1 ) + n γ} {\sum }_{i = T , V , A} \vert 1 - {nw}_{i} \vert , \qquad ( 17 )$$

where n is the number of modalities (n=3), wᵢ is the weight of individual modality to be detailed at next section, y is a predefined constant and fixed to 0.2 in one exemplary experiment.

Adjust Weights Using Relevance Feedback:

Before using AFF to fuse the relevance from three modalities, weights may be adjusted to optimize relevance. Weight adjustment addresses two issues: (1) how to obtain the intra-weights of relevance for each kind of features within a single modality (e.g. w_{T1} and w_{T2} in textual modality); and (2) how to decide the inter-weights (i.e. w_{T}, w_{V} and w_{A}) of relevance for each modality.

Care may need to be taken to select a set of weights satisfying all video documents. For example, for a concept such as “beach”, the visual relevance is more important than the other two, while for a concept such as “Microsoft”, the textual relevance is more important. Therefore, it is preferred to assign different video documents with different intra- and inter-weights.

It is observed that user click-through data usually tell a latent instruction to the assignment of weights, or at least a latent comment on the recommendation results. For example, if a user opens a recommended video and closes it within a short time, it may be an indication that this video is a false recommendation. In contrast, if a user views a recommended video for a relative long time, it may be an indication that this video is a good recommendation having high relevance to the current user interest. Given such a consideration, one embodiment of the present video recommendation system collects user behavior such as user click-through history, in which recommended videos that have failed to retain the user attention may be labeled as “negative”, while recommended videos that have been successful retain the user attention may be labeled “positive”. With positive and negative examples, relevance feedback is an effective way to automatically adjust the weights of different inputs, i.e. intra- and inter-weights.

The adjustment of intra-weights is to obtain the optimal weight of each kind of feature within an individual modality. Among a returned list of recommended videos, only positive examples indicated by the user are selected to update intra-weights as follows

$${w}_{ij} = \frac{1}{{σ}_{ij}} \qquad ( 18 )$$

where i={T, V, A}, σᵢⱼ is the standard deviation of feature fᵢⱼ, whose corresponding document Dᵢ is a positive example. The intra-weights are then normalized between 0 and 1.

The adjustment of inter-weights is to obtain the optimal weight of each modality. For each modality, a recommendation list (D₁, D₂, . . . , D_{K}) is created based on the individual relevance from this modality, where K is the number of recommended videos. The recommendation system first initializes wᵢ=0, and then updates w_{T} as follows

$$\begin{matrix}{w}_{i} = {w}_{i} + 1 , & if {D}_{k} is a positive example \\ = {w}_{i} - 1 & if {D}_{k} is a negative example\end{matrix} \qquad ( 19 )$$

where i={T, V, A} and k=1, . . . , K. The inter-weights are then normalized between 0 and 1.

Dynamic Recommendation:

As an extension of the video recommendation system, a dynamic recommendation based on the relevance between now-playing shot content and an online video is introduced. Referring to FIG. 4, when a video content is displaying in now-playing area 410, the recommended list of online videos displayed in area 420 may be updated dynamically according to current playing shot content. The update may occur at various levels. For example, the update may occur only one a new video has been clicked by the user and displayed in the now-playing area 410.

Additionally or alternatively, the update may occur when new content of the same video has started playing. A video may be played with a series of content shots (e.g., video frames) been displayed sequentially. Although it may be impractical or unnecessary to update the recommendation list for every single frame, it may nevertheless be useful to update the recognition list whenever significant change of content of the now-playing video is detected such that a meaningfully different recommendation list is resulted from the change. In this case, the matching between the present shot (frame) and source videos is based on the local relevance, which can be computed by the same approaches described above.

### Experiments

More than 13k online videos were collected into a video database for testing of the present video recommendation system. A number of representative source videos were used for evaluation. These videos were searched by some popular queries from the video database. The content of these videos covered a diversity of genres, such as music, sports, cartoon, movie previews, persons, travel, business, food, and so on. The selected representative queries came from the most popular queries excluding sensitive and similar queries. These queries include “flowers,” “cat,” “baby,” “sun,” “soccer,” “fire,” “beach,” “food,” “car,” and “Microsoft.” For each source video as the user selected video object, several different video recommendation lists were generated for comparison. These recommendation lists are generated by the following exemplary recommendation schemes for comparison:

(1) Soapbox—the recommendation results from “MSN Soapbox”, as a baseline.

(2) VA (Visual+Aural Relevance)—using linear combination of visual and aural features with predefined weights.

(3) Text (Textual Relevance)—using linear combination of textual features with predefined weights.

(4) MR (Multimodal Relevance)—using linear combination of textual, visual and aural information with predefined weights.

(5) AFF (Attention Fusion Function)—fusing textual, visual and aural information by AFF with predefined weights.

(6) AFF+RF (AFF+Relevance Feedback)—using textual, visual and aural information with relevance feedback and attention fusion function.

The predefined weights used in the above schemes (2)˜(5) are listed in TABLE 1.

TABLE 1
Predefined Weights in Schemes (2)~(5)

| | | |
|---|---|---|
| w_{T} | w_{V} | w_{A} |

| | w_{T} | w_{T} | w_{V} | w_{V} | w_{V} | w_{A} | w_{A} |
|---|---|---|---|---|---|---|---|
| Intra- | 0.5 | 0.5 | 0.5 | 0.3 | 0.2 | 0.7 | 0.3 |

| | | | |
|---|---|---|---|
| Inter- | 0.7 | 0.15 | 0.15 |

For an input video document, a recommended list is first generated for a user according to current intra- and inter-weights; then from this user's click-through, some videos in the list are classified into “positive” or “negative” examples, and the historical “positive” and “negative” lists which are obtained from previous users' click-through were updated. Finally, the intra- and inter-weights were updated based on new “positive” and “negative” lists, and are used for the next user. Test users rated the recommendation lists generated in the experiments.

The results show that the scheme based on multimodal relevance outperforms each of the single modality schemes, and the performance is further improved by using AFF, and still improved by using both AFF and relevance feedback (RF). In addition, the performance increases when the number of users increases, which indicates the effectiveness of relevance feedback.

The test results also indicates the most relevant videos tend to be pushed in the front of recommendation list, promising a better user experience.

### CONCLUSION

An online video recommendation system to recommend a list of most relevant videos according to a user's current viewing is described. The user does not have to have an existing user profile. The recommendation is based on the relevance of two video documents from content-based feature, which can be textual, visual or aural modality. Preferred embodiments use multimodal relevance and may also leverage on relevance feedback to automatically adjust the intra-weights within each modality and inter-weights between modalities based on user click-through data. The relevance from different modalities may be fused using attention fusion function to exploit the variance of relevance among different modalities. The technique is especially suitable for online recommendation of video content.

It is appreciated that the potential benefits and advantages discussed herein are not to be construed as a limitation or restriction to the scope of the appended claims.

Although the subject matter has been described in language specific to structural features and/or methodological acts, it is to be understood that the subject matter defined in the appended claims is not necessarily limited to the specific features or act described. Rather, the specific features and acts are disclosed as exemplary forms of implementing the claims.

What is claimed is:

1. A method for video recommendation, comprising:
obtaining a feature set of a user selected video object, the feature set including at least one content-based feature;
determining or assigning a relevance weight parameter set including a relevance weight parameter associated with the at least one content-based feature;
determining a relevance of each of a plurality of source video objects to the user selected video object with respect to the feature set and the relevance weight parameter set; and
generating a recommended video list of at least some of the plurality of source video objects according to a ranking of the relevance determined for each source video object.

2. The method as recited in claim 1, wherein the at least one content-based feature comprises a visual feature.

3. The method as recited in claim 2, wherein the visual feature comprises at least one of color histogram, motion intensity and shot frequency.

4. The method as recited in claim 1, wherein the at least one content-based feature comprises an aural feature.

5. The method as recited in claim 4, wherein the aural feature comprises at least one of an average aural tempo and a standard deviation of aural tempos.

6. The method as recited in claim 1, wherein the at least one content-based feature comprises a textual feature.

7. The method as recited in claim 6, wherein the textural feature comprises at least one of a text caption, a text generated by automated speech recognition, and a text generated by optical character recognition.

8. The method as recited in claim 6, wherein the textual feature comprises an indirect text generated by automatic text categorization based on a set of predefined category hierarchy.

9. The method as recited in claim 1, wherein the feature set comprises an indirect text generated by automatic text categorization based on a set of predefined category hierarchy, and wherein determining or assigning the relevance weight parameter set comprises:
determining a common ancestor of the user selected video object and the source video object in the predefined category hierarchy; and
determining an indirect text relevance at least partially based a distance information measuring hierarchical separation from the common ancestor to the user selected video object and the source video object.

10. The method as recited in claim 1, wherein the feature set is multimodal comprising a textural modality, a visual modality an aural modality, and wherein the content-based feature belongs to at least one of the textural, visual and aural modalities.

11. The method as recited in claim 1, wherein the feature set comprises multiple features each corresponding to one of a plurality of modalities.

12. The method as recited in claim 11, wherein determining or assigning the relevance weight parameter set comprises:
for each modality, adjusting relevance weight parameters within the modality.

13. The method as recited in claim 11, wherein determining or assigning the relevance weight parameter set comprises:
adjusting relevance weight parameters among the plurality of modalities.

14. The method as recited in claim 1, wherein determining or assigning the relevance weight parameter set comprises:
providing a user click-through history;
determining or adjusting the relevance weight parameter set according to the user click-through history.

15. The method as recited in claim 1, wherein generating the recommended video list is performed dynamically whenever a change has been detected with respect to the user selected video object.

16. The method as recited in claim 15, wherein the change with respect to the user selected video object comprises selection by a user a video object different from the current user selected video object.

17. The method as recited in claim 15, wherein the change with respect to the user selected video object comprises detection of a new now-playing content of the user selected video object, the new now-playing content being substantially different from a previously played content of the user selected video object such that a different recommended video list would be generated based on the new now-playing content.

18. A user interface used for automatic video recommendation, the user interface comprises:
a now-playing area for displaying a user selected video object;
a video content recommendation area for displaying a video recommendation list comprising a plurality of indicia each corresponding to a recommended source video object, wherein the video recommendation list is displayed according to a ranking of relevance determined for each recommended source video object relative to the user selected video object with respect to a feature set and the relevance weight parameter set, the feature set including at least one content-based feature; and
means for making a user selection of a recommended source video object among the displayed video recommendation list, wherein upon selecting the recommended source video object, the user interface dynamically updates the now-playing area and the video content recommendation area.

19. The user interface as recited in claim 18, further comprising:
a supplemental display area for displaying information related to the user selected video object.

20. One or more computer readable medium having stored thereupon a plurality of instructions that, when executed by one or more processors, causes the processor(s) to:
extract from a user selected video object a feature set including at least one content-based feature;
determine or assign a relevance weight parameter set including a relevance weight parameter associated with the at least one content-based feature;
determine a relevance of each of a plurality of source video objects to the user selected video object with respect to the feature set and the relevance weight parameter set; and
generate a recommended video list of at least some of the plurality of source video objects according to a ranking of the relevance determined for each source video object.
